(19) United States
(12) Patent Application Publication
(10) Pub. No.: US 2016/0041565 A1
(43) Pub. Date: Feb. 11, 2016

(54) INTELLIGENT ELECTRONIC WATER FLOW REGULATION SYSTEM

(71) Applicant: Flood Monkey Inc., Tooele, UT (US)

(72) Inventor: Philip D. Edwards, South Jordan, UT (US)

(21) Appl. No.: 14/345,638

(22) PCT Filed: Jan. 7, 2014
(86) PCT No.: PCT/US14/10480

§ 371 Date: Mar. 18, 2014

Related U.S. Application Data
(60) Provisional application No. 61/817,726, filed on Apr. 30, 2013.

(51) Int. Cl. G05D 7/06; G05B 15/02; G05D 27/02; G05D 23/19

(52) U.S. Cl. CPC G05D 7/0635; G05D 23/1919; G05B 15/02; G05D 27/02

(57) ABSTRACT

A control module can include in at least one implementation an electronically actuated water control valve configured to shut off water flow through a water pipe, an electronic flow sensor configured to measure the flow of water through the water pipe, a temperature sensor configured to report water temperature, a water quality sensor, and a processing unit in communication with the electronically actuated water valve and the electronic flow sensor. The processing unit can be further configured to identify irregularities in the flow of the water through the water pipe, and in response to the identified irregularities, shut off the water flow through the water pipe.

### CROSS-REFERENCE TO RELATED APPLICATIONS

The present invention is a 35 U.S.C. §371 U.S. National Stage of PCT Application No. PCT/US14/10480 filed Jan. 7, 2014, entitled “Intelligent Electronic Water Flow Regulation System,” which claims priority to U.S. Provisional Application No. 61/817,726, filed on Apr. 30, 2013, entitled “Cloud Controlled Intelligent Electronic Water Flow Regulation System.” The entire content of each of the aforementioned patent applications is incorporated by reference herein.

### BACKGROUND OF THE INVENTION

1. Technical Field

The present invention relates to the field of plumbing.

2. Background and Relevant Art

Homeowners, facilities managers, and property managers understand the potential threat to their buildings from water damage caused by plumbing leaks. Oftentimes, structural damage caused by water leaks occurs while a property is unoccupied or the occupants are asleep. Many different circumstances and situations can lead to water damage, including frozen pipes that break, valves that fail, pipes or connectors that come loose, refrigerator lines that break, hot water heater tanks that corrode and split, toilet float valves that fail, and many other conceivable events.

Once a leak is detected, a property manager or owner can shut off the water to prevent further damages from occurring. Oftentimes, however, the manager or owner will only detect the leak after significant damage has occurred. Recovering from the resulting water damage can be an expensive and time consuming exercise.

Water exposure can destroy structural materials such as drywall, baseboards, subfloor, electrical fixtures and wiring. Water exposure can also permanently damage finish items such as wallpaper, paint, carpet, pad, vinyl and wood flooring. Additionally, furniture, electrical items, computers, and clothing can all be ruined. Further, in residential buildings, water can destroy irreplaceable items such as pictures, financial records, personal documents, photographs and rare mementos.

Accordingly, there are a number of problems in the art relating to monitoring and controlling water flow through industrial, commercial, and residential plumbing systems.

### BRIEF SUMMARY OF THE INVENTION

Implementations of the present invention comprise systems, methods, and apparatus configured to automatically monitor water characteristics and control water flow through a plumbing system. In particular, at least one implementation of the present invention automatically detects unusually high water usage and shuts down the flow of water. Further, at least one implementation of the present invention can identify “fingerprints” that are associated with normal water flow. For example, a fingerprint can be associated with a dishwasher such that the present invention can identify when a dishwasher is washing dishes.

At least one implementation of the present invention comprises a control module in communication with a plumbing water pipe. The control module can include an electronically actuated water control valve configured to shut off water flow through the water pipe, an electronic flow sensor configured to measure the flow of water through the water pipe, a temperature sensor configured to report water temperature, a water quality sensor, and a processing unit in communication with the electronically actuated water valve and the electronic flow sensor. The processing unit can further be configured to identify irregularities in the flow of the water through the water pipe, and in response to the identified irregularities, shut off the water flow through the water pipe.

In addition, a method in accordance with an implementation of the present invention can include receiving readings from a flow meter disposed within the flow of water through a pipe. The method can also include comparing the detected one or more water flow characteristics with a database of water flow fingerprints. In this case, the database of water flow fingerprints can comprise a list of known water-use appliances and associated water flow characteristics that correspond to each water-use appliance. Furthermore, the method can include determining that the detected one or more water flow characteristics do not fall within a threshold of at least one water flow fingerprint, and notifying a user.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated, in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a schematic diagram of a system for controlling the flow of water through a pipe system;

FIG. 1B illustrates a schematic of a house, the schematic including sub-modules of the present invention;

FIG. 2 illustrates another depiction of an implementation of a control unit of the present invention;

FIG. 3 illustrates yet another depiction of an implementation of a control unit of the present invention;

FIG. 4 illustrates another depiction of an implementation of a control unit of the present invention; and

FIG. 5 illustrates a flow chart depicting an implementation of the present invention.

### DETAILED DESCRIPTION OF THE PREFERRED EMBODIMENTS

Implementations of the present invention extend to systems, methods, and apparatus configured to automatically monitor water characteristics and control water flow through a plumbing system. In particular, at least one implementation of the present invention automatically detects unusually high water usage and shuts down the flow of water. Further, at least one implementation of the present invention can identify “fingerprints” that are associated with normal water flow. For example, a fingerprint can be associated with a dishwasher such that the present invention can identify when a dishwasher is washing dishes.

Accordingly, in at least one implementation, one or more components of the present invention can identify a broken or leaky pipe and shut off the flow of water before substantial damage is incurred. Further, in at least one implementation, one or more components of the present invention can identify water usage patterns and/or water quality and report that information to a user. One will understand that the ability to prevent water damage and the ability to more closely monitor water usage can provide significant benefits to property owners and property managers.

For example, implementations of the present invention can include a unique, “intelligent” wireless node plumbing automation system, apparatus, and process for use in homes and commercial facilities. In at least one implementation, the system can be controlled and monitored through a computer interface. The computer interface can be in direct communication with the system and/or in communication with the system through the Internet. Additionally, the computer interface can comprise a smart phone, a web browser, or some other common computer interface.

The system can also comprise electronic wireless water control apparatuses, electrical circuit isolators, natural gas supply line isolators, and other electronic apparatuses including but not limited to, a wireless bridge component, a USB interface, Ethernet and cellular network interfaces, wireless remote sensor sub-modules, and wireless remote control sub-modules. Additionally, the remote control sub-modules can comprise wireless node mesh network technology for the multi directional transmission of data to electrically powered water control and monitoring apparatuses. Further, the water control apparatuses can comprise water shut off solenoid valve components, water pressure transducer components, water flow sensor components, water temperature sensor components, water quality sensor components, acoustical sound sensor components, and micro hydroelectric generator components.

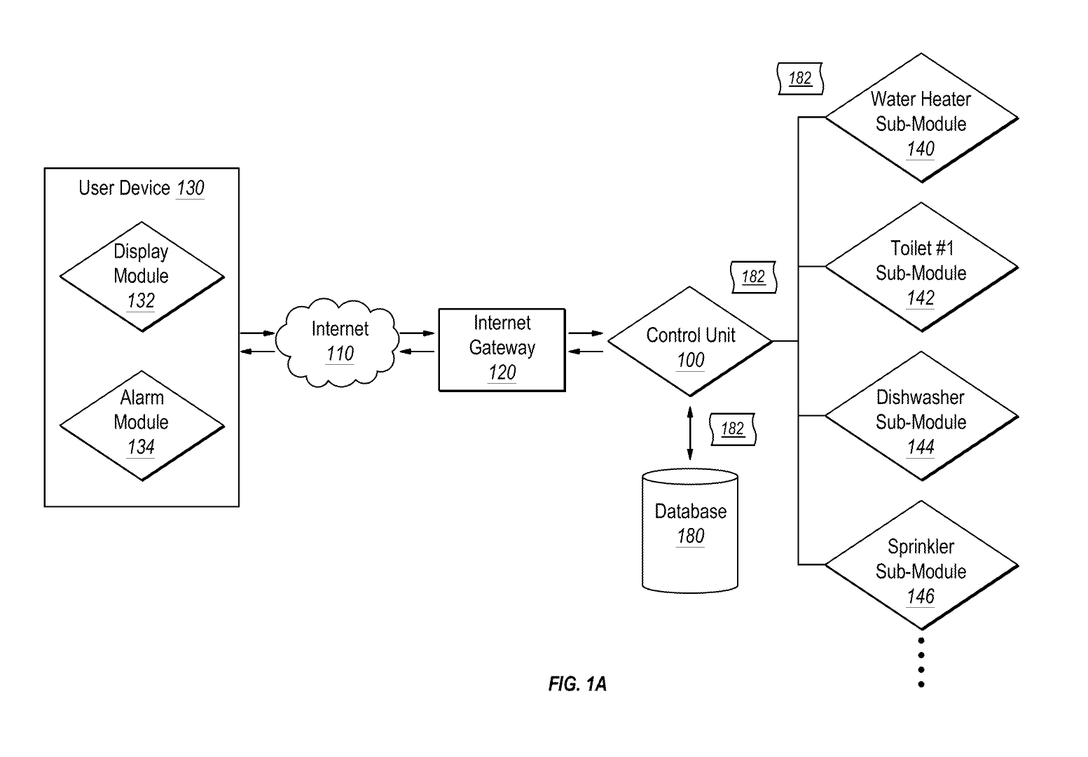

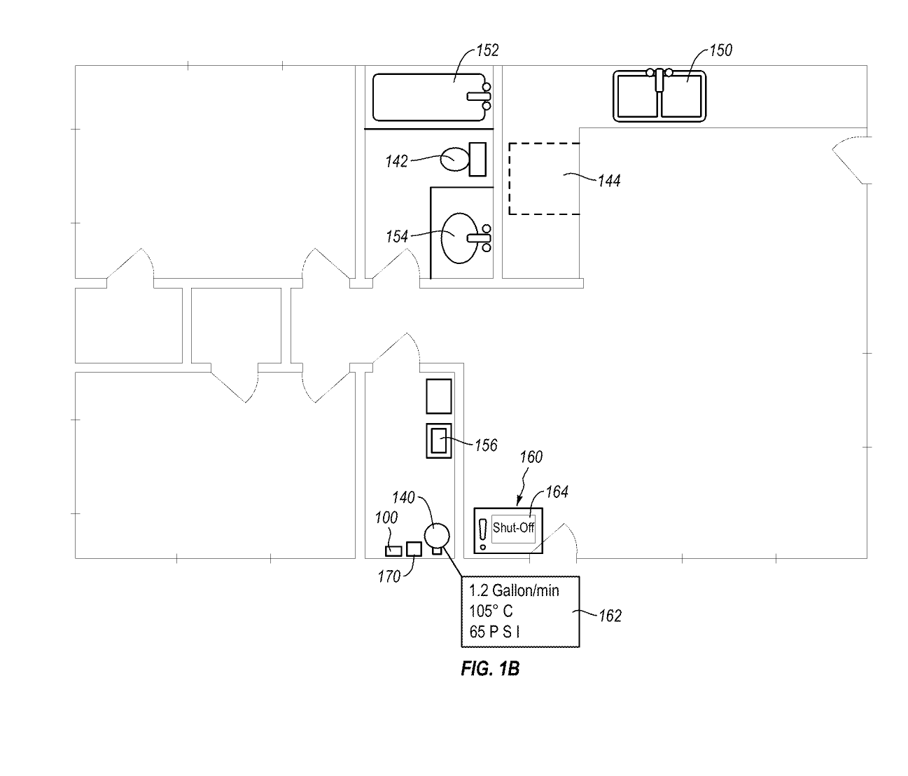

FIG. 1A illustrates a schematic diagram of a user device 130 in communication with an implementation of the present invention. In particular, the schematic depicts a user device 130 in communication through the Internet 110 with an Internet gateway 120. In at least one implementation, the Internet gateway 120 can be a wireless router within a home. The Internet gateway 120, in turn, can communicate with a control unit 100 of the present invention. Specifically, the control unit 100 can comprise a Wi-Fi module that enables the control unit to communicate with the Internet gateway 120.

FIG. 1A also shows that the control unit 100 can be in communication with a plurality of sub-modules 140, 142, 144, 146. The control unit 100 and the sub-modules 140, 142, 144, 146 can be in physical communication (i.e., physical wires, fiber, water based communication, etc.) or wireless communication through any number of known wireless protocols, including but not limited to Bluetooth, WI-FI, Z-Wave, etc. In this way, the control unit 100 can gather and analyze information from the various sub-modules 140, 142, 144, 146 and from sensors contained within the control unit 100 itself. The control unit 100 can then communicate this information to a user device 130 through the Internet 110.

For example, user device 130 can comprise a mobile phone running an application that is designed to interface with the present invention. In alternate implementations, the user device can also comprise a computing device that is accessing a website through which the system can be accessed, a desktop computer running a custom designed application, a dedicated hardware device that is designed to interface with the present invention, or any number of other known interface devices.

As depicted, the user device 130 can include a display module 132 and an alarm module 134. The display module 132 can be configured to display a variety of information received over an Internet connection from the control unit 100. The alarm module 134 can be configured to indicate an alarm when the control unit 100 detects an emergency situation.

The display module 132 can also display a screen that depicts a schematic of a monitored location. For example, FIG. 1B depicts a schematic of a house fitted with one or more components in accordance with an implementation of the present invention. In particular, the schematic of the house depicts the relative location of the control unit 100 and a water heater sub-module 140, a toilet sub-module 142, a dishwasher sub-module 144, a kitchen sink sub-module 150, a bathroom tub sub-module 152, a bathroom sink sub-module 154, and a washing machine sub-module 156. It should be noted that the labels in the accompanying figures point to the actual plumbing appliance; however, one of skill in the art will understand that the sub-modules can be placed within the appliance, directly between the appliance and a plumbing intake, or, in some cases, a significant distance from the appliance but still in line with the appliances plumbing system.

Additionally, the user device 130 can display to a user a variety of information about water flow within a house. For example, a user can access information relating to the overall use of water within the house, the use of water through a particular water use appliance that is associated with a sub-module, the temperature of water within particular sub-modules, or a variety of other information that the sub-modules 140, 142, 144, 146 and control module 100 are capable of gathering. The various detected water flows can be compared to fingerprints stored within a database 180. As such, irregular water flow can be identified when water flow is detected that does not conform to any fingerprint with the database 180.

The database 180 depicted in FIG. 1A is shown in communication with control unit 100. In other implementations, however, each sub-module 140, 142, 144, 146 can be in communication with its own independent database 180. Additionally, in other implementations, the database 180 can be stored on a remote computer with which the control unit 100 and/or the sub-modules 140, 142, 144, 146 are in communication.

As depicted in FIG. 1A, when a sub-module, for example, Water Heater Sub-Module 140, detects water flow, the detected water flow characteristics can be sent in a data packet 182 over a communication network to the control unit 100. In at least one embodiment, flow characteristics can include flow rate, duration of flow, temperature, purity, acoustic measurements (e.g., to detect the sound of water dripping), and other related measurable flow attributes. The control unit 100 can then forward the data packet to database 180 for comparison to the stored fingerprints. In at least one implementation, the control unit 100 determines whether the detected water flow characteristics are outside of a threshold and determines whether to notify a user of irregular water flow. In alternate implementations, the sub-module makes those determinations.

In the case that irregular water flow is detected through a particular sub-module, for example the water heater sub-module 140, the display module 132 can display the schematic of the house with a visual indication notifying the user that the water heater sub-module 140 is detecting irregular water flow. For example, the area of the schematic where the water heater is located can display a signal 160 indicating the irregular readings. In at least one implementation, an irregular water flow is identified when the detected water flow is not within a threshold of one of the fingerprints stored within the database 180. For example, FIG. 1A depicts the display module 132 can also display information 162 relating to the currently detected water flow through the water heater sub-module. For example, the display module 132 can display water volume, duration, pressure, quality, and temperature to a user. Additionally, the display module can provide an option 164 to close or otherwise regulate a valve within the sub-module 140.

In this way, the system can notify a user of irregular water flow. Based upon the user's knowledge of current household activities, the user can then decide whether a water leak has occurred that should be stopped by closing a valve within the sub-module 140. Further, in at least one implementation, the user can be provided with an option to close the valve within the control unit 100. One will understand that in at least one implementation, the control unit 100 is in direct communication with the water main entering the house. As such, closing the valve within the control unit 100 can shut off all water flow to an entire house or building.

Additionally, in at least one implementation, the control unit 100, or some other applicable portion of the system, can include a water line dump 170 that is configured to drain the water from a plumbing system after the control unit 100 has shut-off water to the plumbing system. This may hold particular value when a pipe has broken and is discharging water into a building or home. Once the break is detected, the control unit 100, or some other applicable sub-module 140, 142, 144, 146, 150, 152, 154, 156, can shut off the water to the water system. The water line dump 170 can then engage and discharge the remaining water from the plumbing system and into a drain.

In contrast, if the water line dump 170 were not to engage, the water remaining in the pipes would continue to drain out of the break. In at least one implementation, one or more the sub-modules 140, 142, 144, 146, 150, 152, 154, 156 may also be associated with a water line dump 170 that discharges water from the pipe system downstream from the respective sub-module 140, 142, 144, 146, 150, 152, 154, 156. Further, in at least one implementation, all sub-modules 140, 142, 144, 146, 150, 152, 154, 156 with a water line dump 170 may engage at the same time to empty the pipes as quickly as possible.

In at least one implementation, a user can additionally or alternatively send commands to the control system 100 and sub-modules 140, 142, 144, 146, 150, 152, 154, 156 using the user device 130. For example, a user can set water volume limits for the entire house, or for particular sub-modules 140, 142, 144, 146, 150, 152, 154, 156. As an illustration, a user can send a command to a sub-module 152 associated with a bathroom tub that the sub-module should only allow 25 gallons of water volume to pass through the sub-module 152 between the times of 7:30 AM and 8:30 AM.

Additionally, in at least one implementation, a user can send a command to sub-module 152 associated with the bathroom tub to fill the bathroom tub with water at a particular time. For example, the sub-module 152 can be in communication with a faucet in the bathtub and the bathtub drain, such that the sub-module 152 can close the drain and open the faucet to allow water into the tub. Additionally, the sub-module 152, using an integrated thermometer can determine a proper water temperature with which the tub should be filled. In at least one implementation, the sub-module 152 can be programmed to automatically fill and drain the bathtub at specific times.

In at least one implementation, the bathtub may comprise two or more sub-modules 152, with a drain sub-module integrated into the waste water pipe and a faucet sub-module integrated into the water inlet pipe. In this case, both of these sub-modules may be controllable in a unitary fashion, wherein the devices automatically cooperate when receiving instructions. For example, sending a command to the faucet sub-module to fill the bathtub may automatically cause the drain sub-module to close the waste pipe. One will understand that automatic water control features using sub-modules can similarly be integrated into a variety of different appliances, including but not limited to kitchen sinks, dishwashers, clothes washers, and toilets. Additionally, one will understand that in some implementations, the sub-module 152 may be in communication with electronically actuated faucets and drains.

A user can also adjust settings and preferences that are associated with the present invention. For example, a user can adjust the thresholds that are used to determine whether an emergency situation is occurring. For example, a user may set that a variance of 25%, 10%, or 5% is allowable within the plumbing system before the control unit, or applicable sub-module, identifies a problem. Additionally, the control unit 100 may be able to automatically adjust a threshold based upon normal fluctuations in water usage. As an additional example, a user can change settings that determine when the present invention automatically shuts valves in response to detecting irregular water flow and when the present invention notifies a user and asks for directions. As such, one will understand that using the present invention a user can exercise precise control over the water usage within a home or building.

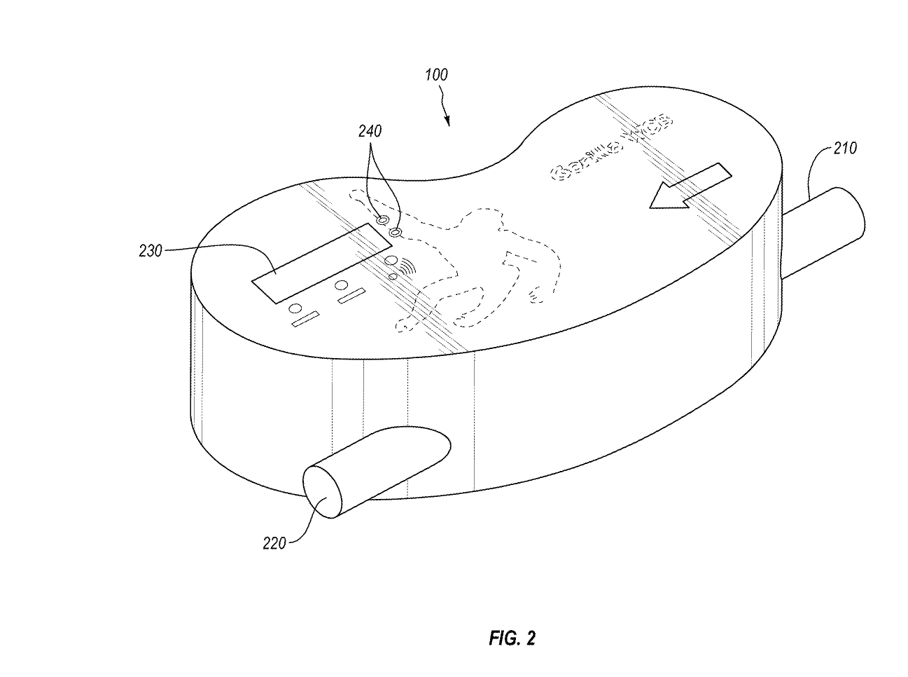

FIG. 2 illustrates a depiction of an implementation of a control unit 100 of the present invention. For example, FIG. 2 shows that at least one implementation of a control unit 100 can comprise an intake channel 210 and an output channel 220. The intake channel 210 and the output channel 220 can interface with plumbing water pipes, such that water flow enters the intake channel 210 and exits through the output channel 220. In at least one implementation, the control unit 100 can be installed near where the water main enters a building or a home. For example, the control unit 100 can be installed within 3 feet of the supply pipe entering a building or home. Additionally, the control unit 100 can be installed down line from the main water shutoff and pressure regulator.

The control unit 100 can also include a display unit 230. For example, FIG. 2 shows that display unit 230 can comprise an LCD display. In other implementations, however, the display unit 230 can comprise any number of components commonly used to communicate information. For example, the display unit 230 can comprise LED lights that communicate information through blinking patterns, through particular colors, or through other schemes that are known in the art.

Additionally, FIG. 2 shows that in at least one implementation, the control unit 100 can include input components 240. For example, the input components 240 can comprise buttons, scroll wheels, touch panels, or other any other input component useful for interacting with a device. In at least one implementation, the control unit 100 can be monitored and controlled with an external computing device that is communicating with the control unit over a network. In this case, the control unit 100 may not comprise a display unit 230 or an input component 240 but can instead be monitored and controlled from the external computing device. Additionally, in at least one implementation, a user can receive real-time information from the computing device relating to the water flow and/or other characteristics of water through the plumbing system.

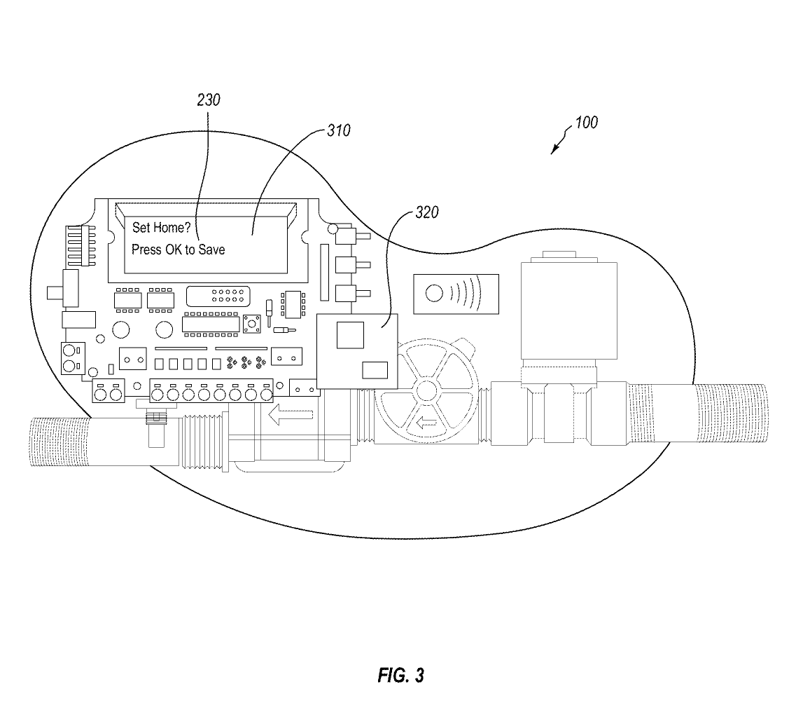

FIG. 3 illustrates a depiction of exemplary internal components of an implementation of the control unit 100. In particular, FIG. 3 depicts a processing unit 310 and a communication unit 320. The processing unit 310 and the communication unit 320 can be in direct communication with each other such that the processing unit 310 can transmit and receive information through the communication unit 320.

In at least one implementation, the communication unit 320 can comprise a wireless transmitter and receiver. In particular, the communication unit 320 can comprise a WI-FI, cellular or Bluetooth chip such that the communication unit can connect to an Internet gateway. Additionally, in at least one implementation, the communication unit 320 can comprise a mesh network chip, such as a Z-WAVE chip. Using the mesh network, the communication unit 320 can communicate with other sub-modules of the present invention disposed in relation to a plumbing system. In particular, the communication unit 320 can be in communication with one or more the sub-modules, which in turn can be in communication with each other and/or other sub-modules.

As depicted in FIG. 3 the processing unit 310 can also comprise a display unit 230. Through the display unit 230, the processing unit 310 can display status information, command options, settings, and other applicable information. In at least one implementation, one or more components of the present invention can be completely controlled and monitored using the processing unit 310 and the display unit 230.

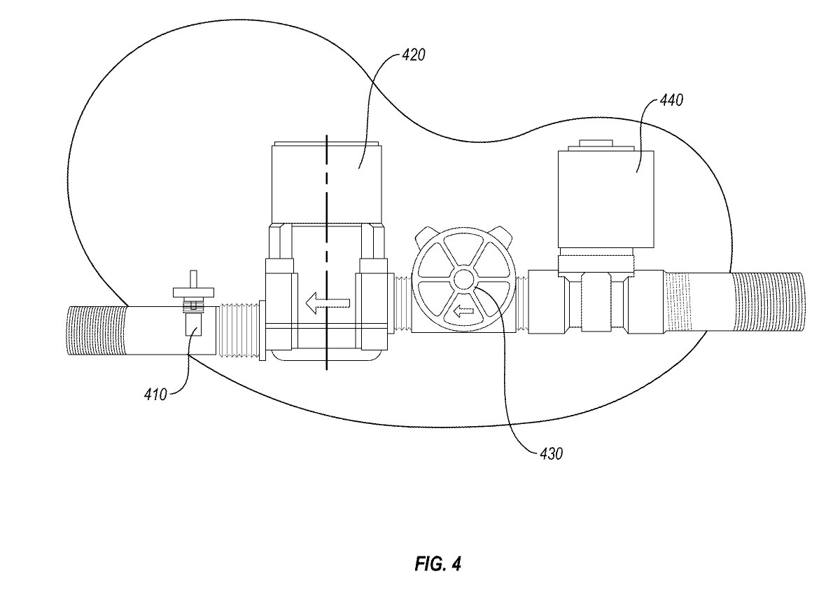

FIG. 4 illustrates a depiction of additional internal components of an implementation of the control unit 100. In particular, FIG. 4 depicts a thermistor 410, a generator 420, a flow meter 430, and a valve 440. In at least one implementation, the processing unit 310 is in communication with each of the thermistor 410, generator 420, flow meter 430, and valve 440. The processing unit 310 can gather data or control the flow of water using any combination of these components.

For example, the processing unit 310 can gather information relating to the flow rate and temperature of the water from the flow meter 430 and the thermistor 410, respectively. Additionally, in at least one implementation, the processing unit 310 can be in communication with devices that detect water pressure, water volume, water purity, etc. The processing unit 310 can also be in communication with the generator 420 such that the generator 420 provides the processing unit 310 with sufficient power to run. In contrast, or in addition, the processing unit 310 can also be in communication with a battery that provides power to the control unit 100.

In at least one implementation, the processing unit 310 can communicate with the valve 440. In particular, the processing unit 310 can be configured to shut the valve 440 such that the flow of water is stopped. Additionally, the processing unit 310 can be configured to adjust the valve 440 to thereby adjust the pressure and/or flow rate of the water within the pipe. One will understand that the processing unit 310, relying upon information reviewed from sensing units (e.g., flow meter 430, thermistor 410, etc.), can use the valve 440 to control characteristics of the water traveling through the control unit 100.

For example, in at least one implementation, the processing unit 310 can be configured to identify an instance of abnormal water usage. For example, the processing unit 310 can detect an abnormal amount volume and/or rate of water flow for an abnormal amount of time. One will understand that this can infer that a pipe has broken, that a faucet has unintentionally been left on, or that some other undesirable event has taken place.

As an additional example, the processing unit 310 can identify a particular characteristic of the water that is concerning. For example, the processing unit 310 can identify that the water is nearing the freezing point. One will understand that water freezing in pipes is a common source of water damage. Additionally, in at least one implementation, the control unit 100 can comprise a purity sensor that can determine if the water contains above a threshold amount of impurities. One will also understand the benefit of a system that can identify an unacceptable amount of impurities in water and notify a user.

In response to detecting abnormal water usage or flow, the processing unit 310 can alert a user, giving the user a chance to indicate if the unusual activity is deliberate. The processing unit 310 can alert the user through an electronically delivered message (e.g., SMS text, email, custom message delivered through an application, etc.), through an alarm sounded by the control unit, or by any other common notification method. If the user is unaware of such deliberate activity, or if he or she is unavailable, the control unit 100 can automatically shut off the water supply until potential leaks can be investigated.

In at least one implementation of the present invention, before a processing unit 310 can identify abnormal water usage, the control unit 100 can be calibrated to the normal water usage or flow. A user can calibrate the processing unit 310 by isolating each type of water use and recording a typical execution of each water use. The “fingerprint” for each activity (such as flushing a toilet, running a shower or bath, running a dishwasher, etc.) is then recorded in the database 180 that the processing unit 310 can later access. As used within this application a “fingerprint” can include those characteristics of the water flow that enable the control unit to identify the causing event.

For example, the control unit 100 can provide a user with an indication to flush a particular toilet a specific number of times. The processing unit 310 can analyze the resulting characteristics of the water flow. In at least one implementation, a user can pre-enter the various water use appliances (i.e., toilets, sinks, laundry machine, etc.) before calibration begins. In at least one other implementation, a user can access the control unit 100 from a mobile device (i.e., a mobile phone, tablet, laptop) and identify in real-time the type of device that is being used. Further, in at least one implementation, the control unit 100 can comprise a database 180 of generic fingerprints that are associated with pre-defined average water use characteristics of water-use appliances.

Additionally, in at least one implementation, the control unit 100 can be in communication with sub-modules that are disposed throughout the plumbing system. The control unit 100 can communicate with the sub-modules through a mesh network, a WI-FI network, or a physical connection. In at least one implementation, the sub-modules comprise the same structure and components as the control unit 100.

One will appreciate that the sub-modules can be disposed at or near the exit point of water from the plumbing system. For example, a sub-module can be disposed before a laundry machine, a bathroom faucet, a toilet, or any other exit point. In at least one implementation, the sub-modules can each comprise sensors, such as flow meters, thermistors, pressure sensors, acoustic sound components, and valves that enable the sub-module to shut off the water.

Additionally, the control module 100 can receive information from the individual sub-modules. In particular, each sub-module can provide the control module 100 with the water characteristic fingerprint of the water exit point, or water-use appliance, that the sub-module is associated with. For example, a sub-module associated with a lawn sprinkler system can communicate to the control module 100 the fingerprint of the water through the law sprinkler system. In particular, the sub-module can send the control module information relating to the water pressure, duration, start time, end time, water volume, etc. The determined fingerprint information can then be stored within a database 180 for later access and comparison.

In at least one implementation, the processing unit 310 can make smart assumptions based upon information that the control unit 100 is receiving. In particular, the processing unit can ascertain which activity (or combination of activities) is being performed. For example, the processing unit 310 can identify within the database 180 a fingerprint associated with a particular toilet and a fingerprint associated with an eco-friendly cycle on a dishwasher. Further, if the current water usage is approximately the sum of the fingerprint of the particular toilet and the fingerprint of the eco-friendly cycle of the dishwasher, the processing unit 310 can identify that both activities are concurrently occurring.

Additionally, using the sub-modules described above, the control unit 100 can identify which activities are taking place by receiving information from the applicable sub-module. For example, a sub-module associated with the particular toilet and a sub-module associated with the dishwasher can communicate to the control unit 100 that their respective water exit points are active. In this way, the control module 100 can identify the activities that are taking place by both analyzing the fingerprints of the water characteristics that have been saved within the database 180 and by receiving information from particular sub-modules.

In addition, the control module 100 can also rely upon the timing of any event to determine what event is taking place. For example, the database 180 may store information with the fingerprint of a shower, where that shower's fingerprint indicates that water most often flows to the shower between 6:15 am and 6:30 am. In this way, when the control unit 100 identifies a flow of water during that time, the control unit 100 can identify that the shower is being used.

One will understand that when using this method it may not be necessary for every water exit point to be associated with a sub-module. For example, the control unit 100 can identify characteristics of water flowing through the control unit. In determining which known fingerprint most closely matches the identified characteristics, the control unit can disregard the fingerprints that are associated with exit points having sub-modules that are not showing any flow. In this way, the number of potential matching fingerprints can be decreased by eliminating obviously incorrect fingerprints that are associated with sub-module not registering any water flow.

Any combination of fingerprints can be detected in this way and the processing unit 310 can make adjustments for changes in flow when multiple activities are being performed at the same time. For example, flushing two toilets at exactly the same time might not produce a fingerprint that is exactly the same as the fingerprints of the two toilets added together. The control unit 100, however, can develop algorithms to identify the proper event, either with or without additional sub-modules.

Additionally, in at least one implementation, the processing unit 310 can be configured to learn and evolve the fingerprints over time. For example, a toilet flush can start off with a particular fingerprint at calibration, but after 6 months of time the fingerprint can change. The processing unit 310, however, can dynamically update the fingerprint with the changes, so that after six months, it will know that a toilet flush comprises a new or adjusted fingerprint, and will be able to successfully identify it as such.

Given that the processing unit 310 can determine usual activities and combinations of activities, in at least one implementation, the processing unit 310 can identify circumstances that do not fit into any fingerprint or combination of fingerprints that have been stored within the database 180. When this occurs, the processing unit 310 can determine that the non-matching activity is the likely result of some kind of unwanted activity, such as a burst pipe, flooding toilet, etc. The processing unit 310 can then react in accordance with its programming parameters, to prevent the unusual water flow from continuing.

In particular, the processing unit 310 can determine if the unidentified activity exceeds a threshold value, such as a threshold time, pressure, or flow value. In one implementation, for example, if the processing unit 310 determines that the unidentified activity is only a minor amount of water flow, the processing unit 310 may allow the activity to continue for a threshold amount of time before re-evaluating the water flow. If the unidentified activity continues past the time threshold the processing unit can initiate an emergency action. In contrast, if the water flow is significant, the processing unit 310 can immediately initiate an emergency action.

For example, in at least one implementation, that control unit 100 can automatically shut-off all water in the building or house in response to detecting a value exceeding a threshold. Similarly or alternatively, in at least one implementation, the control unit 100 can communicate with a sub-module that is associated with the water exit point that is generating the unusual readings. The control unit 100 can order the sub-module to close a valve and stop the flow of water. Additionally, as previously disclosed, in response to detecting unusual activity the control unit 100 can notify a user of the unusual activity and request further direction.

In addition, an implementation of the present invention can communicate to a website the various characteristics of the water flow that the control unit 100 gathers. The website (i.e., a server hosting the website) can then process and analyze the data that is collected from a plurality of different users. Using the communicated data, better algorithms and fingerprints can be developed and identified. This information can then be communicated back to each respective control unit 100.

In at least one implementation, the present invention can also be used to control water usage. In particular, in at least one implementation the control unit 100 can be programmed with specific volume limits to be applied to a particular sub-module. For example, a sub-module associated with a shower can be limited to only a specific volume of water. Additionally, in at least one implementation, the shower may be associated with two different sub-modules—one in communication with the hot water and another in communication with the cold water. The control unit 100 can limit the volume of water with respect to both or only one of the sub-modules.

Further, the control unit 100 can control water flow based upon time of day. For example, the control module 100 can be programmed (e.g., from remote user entry in a mobile device application, website application, or on a local computer system) such that the lawn sprinklers should only be allowed to run during a particular time at night. In this case, a sub-module associated with the lawn sprinklers can keep its valve closed except during the particular time at night. Keeping the valves closed except when the water is needed may help save water that might otherwise be lost to small leaks, which are too small for the control unit 100 to detect.

In yet another implementation, the control unit 100 can communicate with a sub-module adapted to connect to a gas pipe that feeds into a water heater. Similarly, in at least one implementation, the control unit 100 can communicate with a sub-module adapted to connect to an electrical wire that connects to a water heater. In either case, the control unit 100 can prevent components within the water heater from burning out in the event that the water heater malfunctions.

For example, upon detecting a leak and shutting off the water, the control unit 100 can stop the gas and/or the electrical power entering the water heater. This can help prevent the heating elements from malfunctioning if the water level in the water heater drops too far.

Accordingly, FIGS. 1A-5 and the corresponding text illustrate or otherwise describe various components, apparatus, and systems that can be adapted to automatically control the flow of water through indoor plumbing. Specifically, these inventive components, apparatus, and systems can detect a broken or leaking pipe and automatically turn off the flow of water, and can provide a user with greater control over the water use within the user's home or building.

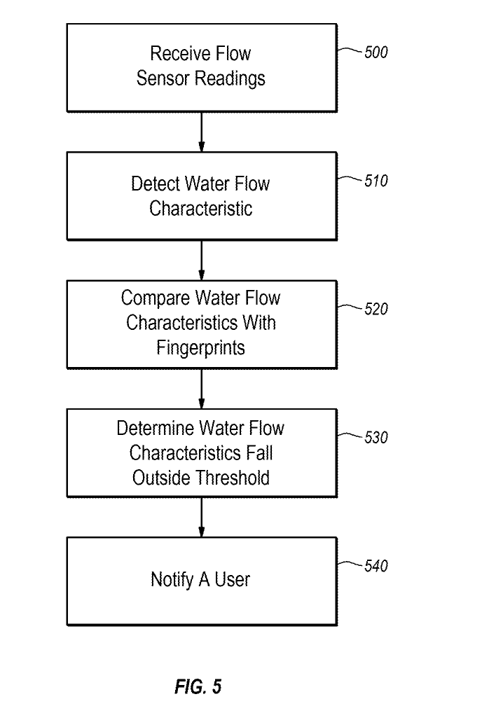

In addition to the foregoing, implementations of the present invention can also be described in terms of methods comprising one or more acts for accomplishing a particular result. Along these lines, FIG. 5 illustrates a method described below with reference to the modules and components of FIGS. 1 through 4.

For example, FIG. 5 illustrates that a method for automatically controlling the flow of water through a pipe system can comprise an act 500 of receiving readings from a flow meter. Act 500 includes receiving readings from a flow meter disposed within the flow of water through a pipe. For example, FIG. 1A shows that a water flow control system 100 can receive readings from a flow meter disposed within a sub-module (see also FIG. 4, which depicts a flow meter 430 disposed within a control unit 100). The control modules 100 can be connected to a water pipe system such that the flow of water engages the flow meter 430.

FIG. 5 also shows that the method can include an act 510 of detecting a flow characteristic. Act 510 includes detecting, with a processing unit, one or more water flow characteristics. For example, FIG. 4 shows a control module (100) that includes various flow detection modules (140, 142, 144, 146). The depicted flow detection modules include a thermistor 410, a generator 420, a flow meter 430, and a valve 440. The flow detection modules, in turn, monitor the flow of water at various points in the system.

Additionally, FIG. 5 shows that the method can an include act 520 of comparing water flow characteristics with fingerprints. Act 520 includes comparing the detected one or more water flow characteristics with a database 180 of water flow fingerprints, wherein the database 180 of water flow fingerprints comprises a list of known water-use appliances and associated water flow characteristics that correspond to each water-use appliance. For example, the control unit shown in FIG. 1A can identify an irregular water flow through a water-heater 140 by comparing the detected water flow with information stored in a database 180.

Further, FIG. 5 shows that the method can also include an act 530 of determining that a water flow characteristic falls out of a threshold. Act 530 includes determining that the detected one or more water flow characteristics do not fall within a threshold of at least one water flow fingerprint. For example, the control unit 100 can identify that the water flow through water heater 140 exceeds a fingerprint in the database 180 by more than a threshold. Accordingly, the control unit 100 can then issue a warning through display module 132, indicating a potential problem.

Further still, FIG. 5 shows that the method can also include an act 540 of notifying a user. Act 540 includes notifying a user by sending one or more electronic signals to a user device at a remote location. For example, control unit 100 can send a notification of irregular water flow detected in the water heater 140. The notification, in turn, can comprise a warning 160 and with information 162 relating to the detected water flow that is displayed at user device 130. As previously discussed with respect to FIG. 1A, device 130 can comprise a mobile device, or a computer connected remote of the internet gateway 120 and/or control unit 100 over internet 110. Using the information retrieved through device 130, the user can then activate a shut-off feature 164 through device 130. The activated feature can result in a signal being relayed from device 130 back to control unit 100 over the internet 110, and which causes control unit 100 uses to stop further water flow.

Accordingly, FIG. 5 and the corresponding text illustrate or otherwise describe one or more components, modules, and/or mechanisms for automatically identifying unusual water flow through a water pipe system, and responding appropriately. One will appreciate that implementations of the present invention can automatically identify a water leak and aid in limiting damage by shutting down the pipe system. Additionally, implementations of the present invention can provide users with additional information relating to the water use of a particular structure. For example, using systems and methods described above, a user can identify what water appliances are using the highest amount of water. A user can then make necessary adjustments to the water use of the structure.

Additionally, implementations of the methods and systems described above allow a user to remotely monitor the water usage of a building or residence. This may be particularly valuable to landowners that do not live near a particular property. For example, a landowner may own a weekend rental property near a destination resort, but the landowner may live a significant distance away from the property, such that the landowner is not able to easily visit the property. One or more of the implementations of the methods and systems described above can allow the landowner to monitor the water usage of the property from a distance.

In additional implementations of the systems and methods described herein, the flow control system can be incorporated into a gas line system, an air flow system, or any other fluid based system. For example, a building with extensive heating needs may comprise several different gas lines running through the building to various heating units. In at least one implementation, the structures, systems, and methods described above can be incorporated into the gas line system such that excessive use and/or potential gas leaks can automatically be detected and stopped. One will understand that the above disclosed systems, methods, and apparatus can be used in a variety of different systems beyond the gas and water system discussed.

Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The embodiments of the present invention may comprise a special purpose or general-purpose computer including various computer hardware components, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. An intelligent electronic water flow regulation system, the system comprising:
a control module in communication with a plumbing water pipe, the control module comprising:
an electronically actuated water valve configured to shut off water flow through the water pipe;
an electronic flow sensor configured to measure the flow of water through the water pipe; and
a processing unit in communication with the electronically actuated water valve and the electronic flow sensor, wherein the processing unit is configured to identify irregularities in the flow of the water through the water pipe, and in response to the identified irregularities, shut off the water flow through the water pipe.

2. The system as recited in claim 1, wherein the control module is connectable to the internet.

3. The system as recited in claim 2, wherein the control module communicates with a webpage.

4. The system as recited in claim 2, wherein the control module communicates with an Internet connected application.

5. The system as recited in claim 1, wherein the control module is configured to form a mesh network with at least one other sub-module.

6. The system as recited in claim 1, wherein the processing unit is configured to identify fingerprints, associated within individual appliances that are in communication with the water pipe.

7. The system as recited in claim 1, further comprising:
an electrical switch in communication with a power source of a water heater, wherein the processing unit, through the electrical switch, can shut off power to the water heater.

8. The system as recited in claim 1, further comprising:
a gas valve in communication with a gas source of a water heater, wherein the processing unit, through the gas valve, can shut off gas to the water heater.

9. The system as recited in claim 1, further comprising:
a plurality of sub-modules in communication with a single plumbing system;
the plurality of sub-modules each associated with one or more appliances; and
wherein the plurality of sub-modules are in communication with each other.

10. The system as recited in claim 1, further comprising:
a water quality sensor configured to identify levels of impurities within water;
wherein the processing unit is configured to identify irregularities in the quality of the water through the plumbing water pipe, and in response to irregularities inform the user through a user interface.

11. A computerized method for electronically monitoring and controlling the flow of an element through a pipe using a control unit that electronically measures an element characteristic and sends the results of the monitoring to a user at a remote location, the method comprising:
a control unit receiving one or more electronic readings from an element characteristic sensor disposed within the flow of element through a pipe;
detecting, with a processing unit, one or more element characteristics from the received one or more electronic readings;
comparing the detected one or more element characteristics with a database of element characteristic fingerprints, wherein the database of element characteristic fingerprints comprises a list of known element-use appliances and associated element characteristics that correspond to each element-use appliance;
determining that the detected one or more element characteristics do not fall within a threshold of at least one element characteristic fingerprint; and
notifying a user by sending one or more electronic signals to a user device at a remote location.

12. The method as recited in claim 11, wherein:
the element comprises water;
the element characteristics comprises the flow of water through the pipe; and
the element characteristic fingerprint comprises a water flow fingerprint.

13. The method as recited in claim 12, further comprising:
determining one or more water flow characteristics that correspond with a water-use appliance; and
storing the one or more water flow characteristics within a database of water flow fingerprints.

14. The method as recited in claim 13, wherein determining the one or more water flow characteristics that correspond with a water-use appliance comprises:
identifying the water volume, water pressure, and duration of a water flow associated with a water-use appliance.

15. The method as recited in claim 14, wherein determining the one or more water flow characteristics that correspond with a water-use appliance further comprises:
identifying a time frame in which a particular flow water-use appliance is typically in use.

16. The method as recited in claim 13, wherein determining the one or more water flow characteristics that correspond with a water-use appliance further comprises:
identifying the water volume, water pressure, and duration of a toilet flush.

17. The method as recited in claim 12, further comprising:
determining that a water temperature characteristic does not fall within a threshold of at least one pre-defined water flow fingerprint.

18. The method as recited in claim 12, further comprising:
determining that a water quality characteristic does not fall within a threshold of at least one pre-defined water flow fingerprint.

19. The method as recited in claim 12, further comprising:
upon determining that the one or more water flow characteristics do not fall within a threshold of at least one pre-defined water flow fingerprint, automatically shutting off the flow of water.

20. An intelligent electronic water flow regulation system, the system comprising:
a control module in communication with a plumbing water pipe, the control module configured to:
receive readings from one or more sensors disposed within the flow of water through the pipe;
detect, with a processing unit, the water volume, water pressure, and duration of a water flow inducing event;
compare the detected water volume, water pressure, and duration of the water flow inducing event with a database comprising water flow fingerprints of various different water inducing events;
determine that the water flow characteristic does not fall within a threshold of at least one water flow fingerprint; and
notify a user.
